(19) United States
(12) Patent Application Publication
(10) Pub. No.: US 2005/0172671 A1
(43) Pub. Date: Aug. 11, 2005

(54) Methods of manufacturing molded glass articles

(75) Inventors: Yasuhiro Yoneda, Iida-shi (JP); Hiroyuki Sawada, Iida-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/602,706

(22) Filed: Jun. 25, 2003

(30) Foreign Application Priority Data
Jun. 26, 2002 (JP) 2002-185474

(51) Int. Cl. C03B 11/12

(52) U.S. Cl. 65/64; 65/102; 65/29.19; 65/25.1

(57) ABSTRACT

Disclosed is methods of manufacturing optical elements such as optical glass lenses and to methods of manufacturing optical glass elements in which a heat softened optical glass material is press molded in a pressing mold with high precision. Optical pick up units is also disclosed and it comprises an object lens manufactured by the method. In the method, at least one of an upper mold and a lower mold having a shape such that when a glass material is in contact with the upper mold and the lower mold, a molding surface of at least one of the upper mold or the lower mold forms a closed space with a surface of the glass material. The method comprises the steps of supplying a glass material, at a temperature of less than a temperature at which the glass material exhibits a viscosity of 10¹¹ poises, between the upper mold and the lower mold; heating the supplied glass material by thermal conduction by means of contact with the upper mold or lower mold on the side on which the space is formed; and moving at least one of the upper mold and the lower mold at an average moving rate of less than or equal to 10 mm/min at least for a distance h micrometers after the glass material becomes in contact with the upper mold and the lower mold, when a temperature of the pressing mold is at a predetermined temperature T2 within a range in which the glass material exhibits a viscosity of from 10^{7.4} to 10^{10.5} poises, wherein a maximum height of the space in the direction of the moving of the movable mold is denoted as h micrometers.

### TECHNICAL FIELD

The present invention relates to methods of manufacturing optical elements such as optical glass lenses and to methods of manufacturing optical glass elements in which a heat softened optical glass material is press molded in a pressing mold with high precision.

### BACKGROUND OF THE INVENTION

In recent years, methods of manufacturing optical elements such as the optical glass lenses employed in optical devices such as cameras, optical pick-up units, and the like have been proposed in which a heat-softened optical glass material is press molded in a mold of metal, ceramic, or the like. The optical glass material may be in any of a variety of shapes, such as a sphere, rod or oblate ellipse. There are cases where press molding must be conducted in a configuration in which closed spaces are formed between the mold and the optical glass material due to the shape of the molded optical element, that is, to the shape of the pressing mold. In such cases, when the gas trapped in the spaces is not discharged from the spaces as press molding progresses, indentations are formed on the molded glass surface in areas where gas has remained. As a result, appearance of the molded optical element may be affected.

Some methods of solving this problem have been proposed.

For example, Japanese Unexamined Patent Publication (KOKAI) Heisei No. 6-9228 discloses a method in which the molding pressure is temporarily released and then reapplied to discharge gas remaining between the mold and preform.

Japanese Unexamined Patent Publication (KOKAI) Heisei No. 8-325023 discloses a method in which grooves or notches are provided along the perimeter of the mold, facilitating the discharge of gas remaining between the mold and the preform as the preform extends during pressing.

Japanese Unexamined Patent Publication (KOKAI) Showa No. 61-99101 discloses a method in which small holes are provided in the center of the pressing mold, with gas between the mold and the preform being discharged through the holes.

Further, Japanese Unexamined Patent Publication (KOKAI) Heisei No. 11-236226 discloses a method of pressing in which gas is removed at the outset by generating an ambient vacuum.

However, the inventions described in the above-cited publications have the following problems.

In the method in which the molding pressure is temporarily released and then reapplied (Japanese Unexamined Patent Publication (KOKAI) Heisei No. 6-9228), mold is separated from the glass because the pressure is released at the pressing temperature to discharge gas. Mold separation at high temperature may causes adhere of the melted glass or results in a defective external appearance of the optical glass element.

In the method in which grooves or notches are provided along the perimeter of the mold (Japanese Unexamined Patent Publication (KOKAI) Heisei No. 8-325023), the shapes of the notches and grooves are transferred to pressed optical elements in the form of protrusions, causing the optical elements to lose their intrinsic functions. Further, when the protrusions compromise the function or performance of an optical element, a post-processing removal step becomes necessary, presenting a drawback in the form of increased cost.

In the method in which small holes are provided in the center of the pressing mold (Japanese Unexamined Patent Publication (KOKAI) Showa No. 61-99101), protrusions form in the center of the optical element, requiring post-processing for removal of the protrusions and increasing cost. Further, in the case of aspherical surface shapes, regeneration of the shape is disadvantageously difficult in post-processing.

In the method of generating a vacuum in a pressing atmosphere (Japanese Unexamined Patent Publication (KOKAI) Heisei No. 11-236226), there are drawbacks in that a portion of the glass components of the preform may volatize, with deposition of volatile material degrading the external appearance of the optical element and reducing yield.

The present invention was devised to solve the problems of the inventions of the above-cited publications. That is, the present invention has for its object to provide a method of manufacturing molded articles of optical glass having good external appearance using an ordinary pressing mold, even when press molding must be conducted in a state in which space containing gas is present between the mold and the preform, such as in presses in which the radius of curvature of the glass material (preform) is greater than the radius of curvature of the molding surface of the mold, in a manner permitting the discharge of gas remaining in the space without the need for grooves, notches, or center holes, and without the need to generate a vacuum during press molding.

In the present invention, devised to achieve the above-stated object, a preform is heated while in contact with a pressing mold with which a space is formed and the rate of movement of the mold at the start of pressing is controlled to permit press molding with essentially no gas remaining in the space, permitting the manufacturing of optical glass elements with good shape precision.

### SUMMARY OF THE INVENTION

The present invention relates to a method of manufacturing optical glass elements by press molding a glass material with a pressing mold comprising an upper mold and a lower mold, at least one of the upper mold and the lower mold being vertically movable,
at least one of the upper mold and the lower mold having a shape such that when the glass material is in contact with the upper mold and the lower mold, a molding surface of at least one of the upper mold or the lower mold forms a closed space with a surface of the glass material,
which method comprising:
supplying a glass material, at a temperature of less than a temperature at which the glass material exhibits a viscosity of 10¹¹ poises, between the upper mold and the lower mold
heating the supplied glass material by thermal conduction by means of contact with the upper mold or lower mold on the side on which the space is formed, and,
moving at least one of the upper mold and the lower mold at an average moving rate of less than or equal to 10 mm/min at least for a distance h micrometers after the glass material becomes in contact with the upper mold and the lower mold, when a temperature of the pressing mold is at a predetermined temperature T2 within a range in which the glass material exhibits a viscosity of from 10^{7.4} to 10^{10.5} poises,
wherein a maximum height of the space in the direction of the moving of the movable mold is denoted as h micrometers.

The present invention further relates to a method of manufacturing optical glass elements by press molding a glass material with a pressing mold comprising an upper mold and a lower mold, at least one of the upper mold and the lower mold being vertically movable,
at least one of the upper mold and the lower mold having a shape such that when the glass material is in contact with the upper mold and the lower mold, a molding surface of at least one of the upper mold or the lower mold forms a closed space with a surface of the glass material,
which method comprising:
supplying a glass material between the upper mold and the lower, and moving at least one of the upper mold and the lower mold at an average moving rate of less than or equal to 10 mm/min at least for a distance h micrometers after the glass material becomes in contact with the upper mold and the lower mold, when a temperature of outer surface of the supplied glass material is higher than the interior of the glass material and the outer surface is at a predetermined temperature T1 within a range in which the glass material exhibits a viscosity of from 10^{7.4} to 10^{10.5} poises,
and the temperature of the pressing mold is at a predetermined temperature T2 within a range in which the glass material exhibits a viscosity of from 10^{7.4} to 10^{10.5} poises,
   wherein a maximum height of the space in the direction of the moving of the movable mold is denoted as h micrometers.

The present invention also relates to an optical pick up unit comprising a semiconductor laser source, a collimator lens, a beam splitter, a ¼ wave plate, an iris, an object lens, a detective condensing lens, a photo-detector, and an actuator, wherein the object lens is manufactured by the above-mentioned method of the present invention.

### BRIEF DESCRIPTION OF THE DRAWINGS

FIG. 1 is a vertical cross-sectional view of the peripheral portion of the mold of the press device for molded glass articles employed in Example 1.

FIG. 2 shows a press schedule employed in Example 1.

FIG. 3 is a vertical cross-sectional view of the mold used in Example 2.

FIG. 4 is a drawing descriptive of the closed space formed between the lower mold and the glass material.

FIG. 5 is a schematic cross-sectional diagram of the device used to float a preform 4 employed in Example 3.

FIG. 6 is a drawing descriptive of the pick-up optical unit for optical disks of the present invention.

Further, in the above-described methods of manufacturing of the present invention, the followings are preferred embodiments:
(1) the method further comprises heating the glass material so that the outer surface of the glass material reaches a temperature T1 in which the glass material exhibits a viscosity of from 10^{7.4} to 10^{10.5} poises prior to supplying the glass material between the upper mold and the lower mold (this embodiment is only for the second method as set forth in Claim 6);.
(2) at least one of the upper mold and the lower mold which forms the closed space has a concave surface with a paraxial radius of curvature r1 in the molding surface and the surface of the glass material which forms the closed space with the molding surface has a convex surface with a radius of curvature r0, wherein r1<r0;
(3) a pressure applied to the glass material by moving at least one of the upper mold and the lower mold is increased on or after the time when the moving distance of said mold reaches the distance h micrometers after the glass material becomes in contact with the upper mold and the lower mold;
(4) the average increasing rate of the pressure is less than or equal to 0.5 kgf/mm² per second; and
(5) the average moving rate of at least one of the upper mold or the lower mold is increased on or after the time when the moving distance of said mold reaches the distance h micrometers after the glass material becomes in contact with the upper mold and the lower mold.

### BEST MODE OF IMPLEMENTING THE INVENTION

The present invention is a method of manufacturing glass optical elements using a pressing mold having upper and lower molds by press molding a glass material.

The case where the glass material is a preform is described below, but the invention is also applied when the glass material is a glass gob or the like.

In the pressing mold employed in the manufacturing methods of the present invention, at least either the upper mold or the lower mold moves vertically. Normally, either the upper mold or the lower mold moves upward and downward.

Further, in the pressing mold employed in the manufacturing methods of the present invention, at least either the upper mold or the lower mold has a shape such that when said glass preform is positioned within said pressing mold and said preform is in contact with said upper mold and said lower mold, the surface of at least said upper mold or said lower mold forms a closed space with the surface of said preform. The upper mold, the lower mold, or both may form closed spaces with the surface of the preform.

In the present invention, a pressing mold having the above-stated functions and shape is employed. A preform is supplied between the upper and lower molds of the pressing mold at a temperature lower than the temperature at which said preform exhibits a viscosity of 10¹¹ poises. Next, the glass material is heated by thermal conduction by the upper mold and/or lower mold on the side(s) of the space.

When only the lower mold forms a closed space with the surface of the preform, the preform is supplied onto the molding surface of the lower mold, and subsequently, the preform is heated by the lower mold by thermal conduction. Heating the preform by thermal conduction through the lower mold may be conducted with or without the preform being in contact with the upper mold.

When the surface of the preform forms a closed space with the upper mold, after supplying the preform onto the lower mold, either the upper or lower mold is moved in a direction reducing the space between the upper and lower molds. This brings the upper mold and the preform into contact, at which point the preform is heated through the upper mold by thermal conduction. In this process, the preform is also in contact with the lower mold; when the temperature of the lower mold is higher than that of the preform, the preform is also heated through the lower mold by thermal conduction.

As set forth above, when there is space between the upper mold or lower mold and the preform on just one side, it does not matter if that side is the upper or lower mold side. However, having the space on the lower mold side of the preform is desirable in that heating can be conducted by thermal conduction through the lower mold and the heating time can be shortened simply by positioning (supplying) the preform.

When there are closed spaces between the surface of the preform and both the upper mold and the lower mold, the preform is supplied to the lower mold, the upper mold or the lower mold is moved in a direction reducing the space between the upper and lower molds to bring the preform in contact with the upper mold, and the preform is heated by thermal conduction through the upper mold and the lower mold.

The temperature of the preform supplied to the lower mold may be room temperature or preheating may be conducted. However, preheating the preform is desirable because it permits a shortening of the molding (the time required to manufacturing a molded article in one cycle). When preheating the preform, the preheating temperature is desirably less than the temperature at which a viscosity of 10¹¹ poise is exhibited. A preform that has been preheated to such a temperature is also desirable when employing a suction member in the course of supplying the preform to the pressing mold.

Further, the preheating temperature of the preform is preferably less than or equal to the glass transition temperature. This is because when the preform is brought into contact with a member such as a conveyor dish and heated, the preform sometimes deforms when heated to a temperature exceeding its glass transition temperature.

The temperature of the upper and lower molds when supplying the preform is desirably a temperature greater than the surface temperature of the preform being supplied but not exceeding a temperature corresponding to a glass material viscosity of 10^{7.4} to 10^{10.5} poises. The temperature of the upper and lower molds is desirably substantially identical.

The preform that has been preheated to the above-stated temperature is then further heated by thermal conduction through contact with the upper mold and/or lower mold, desirably in such a manner that the surface portion of the preform assumes a temperature greater than that of the interior portion, reaching a prescribed temperature T1 falling within a temperature range corresponding to a viscosity of the surface portion of from 10^{7.4} to 10^{10.5} poises.

The above-described heating of the preform is conducted by thermal conduction through the molds. Simultaneous with heating of the preform by thermal conduction through the molds, the molds and/or preform may be heated from the exterior. For example, simultaneous with heating of the preform by thermal conduction through the molds, a heater positioned along the perimeter of the pressing molds may be used to heat the molds and/or preform.

The step of heating the preform by thermal conduction through the mold is desirably conducted for from 10 to 100 seconds. Further, when the temperature of the pressing mold reaches a prescribed temperature T2 for the start of pressing, this step may further comprise a step of maintaining temperature T2 for a prescribed period. Thus, it is possible to control (promote) softening of the near surface of the preform. In this manner, the supplying of heat to the preform by the mold surface with which the preform comes into contact is controlled (promoted), and due to the thermal characteristics of the preform (primarily, a low thermoconductive characteristic), the surface temperature of the preform increases and the temperature of the center portion is lower, generating a suitable temperature distribution. The above-mentioned prescribed period also depends on the volume of the preform from the perspective of achieving a suitable temperature distribution, with from 10 to 200 seconds being suitable. The use of a step of controlling (promoting) softening of the preform in the vicinity of the surface thereof is not essential. However, when beginning pressing, the presence of a temperature distribution (differential) between the surface and interior portions of the preform is desirable to achieve an effect of discharging gas from within the space(s) formed between the preform and the pressing molds. However, it is undesirable for this period to be excessively long because the temperature distribution (differential) decreases, making it hard to achieve the gas discharging effect and lengthening the molding cycle time.

The following modes of the present invention are also desirable. The preform is supplied between the upper and lower molds. When the surface portion of the preform that has been supplied during press molding between the upper and lower molds is at a prescribed temperature T1 higher than the temperature in the interior of the preform and falling within a temperature range at which a viscosity of from 10^{7.4} to 10^{10.5} poises is exhibited, and when the temperature of the pressing mold is at a prescribed temperature T2 falling within a temperature range at which the preform exhibits a viscosity of from 10^{7.4} to 10^{10.5} poises, at least either the upper mold or lower mold is moved at an average moving rate of less than or equal to 10 (mm/min) until reaching a distance of h (micrometers) in a direction decreasing the distance between the upper and lower molds, pressing the preform.

The preform may be heated to cause the temperature of the surface portion thereof to reach prescribed temperature T1 by thermal conduction through the molds as set forth above after being supplied between the upper and lower molds, or may be supplied between the upper and lower molds after having been heated to the above-stated prescribed temperature outside the upper and lower molds.

The case where the preform is heated to a prescribed temperature T1 outside the upper and lower molds before being supplied between the upper and lower molds will be described next.

The preform may be heated to the above-stated prescribed temperature, that is, a temperature corresponding to a glass viscosity of from 10^{7.4} to 10^{10.5} poises, by a heating means outside the molds. Preferably, the temperature corresponds to from 10^{7.5} to 10^{9.4} poises. The preform may be heated to this temperature through its surface by a high-temperature gas flow or infrared radiation, for example.

The temperature of the upper and lower molds when feeding the preform is desirably greater than or equal to the surface temperature of the preform but does not exceed a temperature corresponding to a viscosity of the preform of from 10^{7.4} to 10^{10.5} poises. However, this temperature may be equal to or less than the surface temperature of the preform but higher than the internal temperature of the preform. The temperature of the upper mold and lower mold is desirably substantially identical.

In both the case where the preform is heated between the upper and lower molds and the case where the preform is heated outside the molds, when the temperature of the surface portion of the preform is T1 falling within a temperature range corresponding to from 10^{7.4} to 10^{10.5} poises, pressing may be started.

At that time, the surface portion of the preform is hotter than the interior thereof. That is, a temperature differential is generated between the surface and interior of the preform. Here, the term “interior” means the portion of the preform containing its center. For example, when the preform is spherical with a radius of R, the portion within R/2 from the center can be taken as the interior. The temperature of the interior is desirably less than a temperature corresponding to a glass viscosity of 10^{10.5} poises.

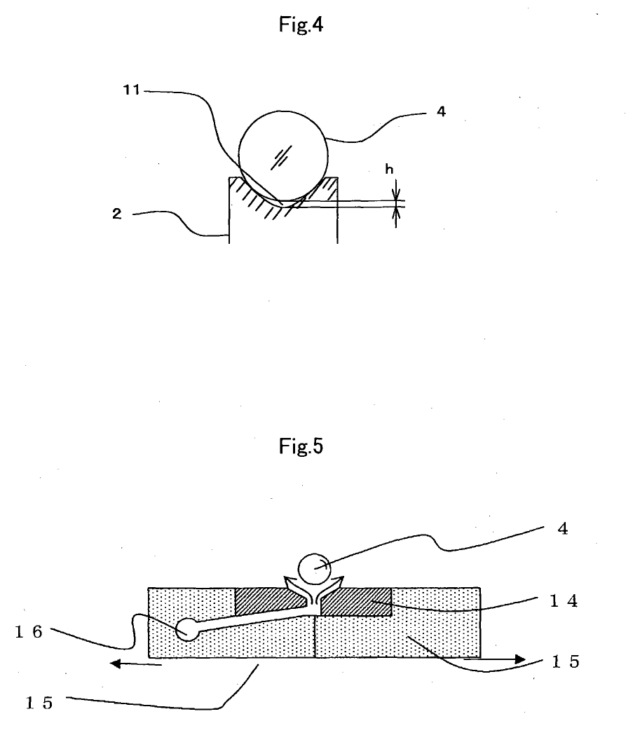

When the preform is fed and the temperature of the pressing mold is a prescribed temperature T2 falling within a temperature range over which the preform exhibits a viscosity of from 10^{7.4} to 10^{10.5} poises, or once the above-described control (promoting) step has been conducted at a prescribed temperature of T2, at least either the upper mold or the lower mold is moved in the direction of reducing the vertical distance between the upper and lower mold at an average moving rate of less than or equal to 10 (mm/min) until reaching a distance of h (micrometers). The average moving rate is desirably from 0.3 to 6.0 (mm/min), preferably from 0.5 to 4.0 (mm/min). h (micrometers) denotes the maximum height of the above-described space in the direction of movement of the pressing mold. When space is produced with either the upper or lower mold, the maximum height of the space in the direction of movement of the mold is denoted as h (micrometers). FIG. 4 shows the case where a closed space 11 is formed between lower mold 2 and preform (glass material) 4. When both the upper mold and the lower mold form closed spaces with the preform, h (micrometers) denotes the sum of the maximum heights of the two spaces.

The phrase “until reaching distance of h (micrometers)” means movement over a distance of h (micrometers) from the point where at least the upper mold and the lower mold are brought into contact with the preform, exerting a load on the preform and causing the preform to start deforming.

For example, the movement of the lower mold may be effected by applying the force of a cylinder, motor, or the like to the bottom member of the lower mold to lift it. The rate at which the lower mold is raised immediately after the start of movement is kept less than or equal to 10 mm/min; the lower mold is raised further, whereby pressure is exerted on the preform. This rate of raising the lower mold is essentially maintained at least until the preform has been moved a distance of maximum height h (micrometers) in the direction of movement of the closed space(s) formed between the preform and the mold molding surface(s).

The temperature T2 of the molds at the start of mold movement is desirably set to a temperature corresponding to a glass viscosity falling within a range of from 10^{7.4} to 10^{10.5} poises, preferably within a range of from 10^{7.5} to 10^{9.5} poises, because such a temperature in the vicinity of the surface of the preform causes the gas in the spaces formed between the preform and the molds to expand radially outward and be discharged without expanding in the direction of the center of the preform.

Further, the temperature of the pressing molds desirably remains within the above-stated range until press molding is completed. For example, the temperature T2 at the start of pressing can be constantly maintained.

At the start of mold movement, the molds are sometimes damaged when high pressure is applied because the viscosity of the preform surface is relatively high and the contact area between the mold and the preform is small. Accordingly, the pressure is desirably low at the start of pressing. For example, a pressure of from 1 to 10 kgf/mm² is suitable. Over the period from the start of pressing to the end, the pressure is desirably greater than or equal to 1 kgf/mm².

In the manufacturing methods of the present invention, since the initial moving rate of the lower mold exerting pressure on the preform is made less than or equal to 10 mm/min, the initial pressure from the mold is gradually transmitted to the preform, the surface of the preform facing the space formed between the preform and the mold gradually deforms, and the gas in the space tends to gradually expand radially and be discharged. The initial moving-rate of the lower mold is desirably less than or equal to 6.0 mm/min, preferably less than or equal to 4.0 mm/min, and even more preferably less than or equal to 3.0 mm/min. The same holds true for the case that upper mold is movable.

When the lower mold has moved a distance h, the pressure can be gradually increased. This is because when a low pressure is maintained, the pressing time increases and production efficiency decreases. Transmitting heat to the center portion of the preform and gradually increasing the pressure permits a shortening of the pressing time without damaging the molds. The increase in pressure at this time may be continuous or intermittent, with either positive or negative acceleration. The average rate of increase in pressure is desirably less than or equal to 0.5 kgf/mm²/sec, preferably less than or equal to 0.1 kgf/mm²/sec. Once the lower mold and/or upper mold has reached distance h, the moving rate of the lower mold and/or upper mold may be increased to greater than or equal to 10 mm/min.

When the gas in the space has been discharged and the preform has been molded into an optical element of desired thickness, the pressure on the preform is released. Subsequently, the molded glass article is cooled at a rate that does not result in deterioration of surface precision, separated from the upper mold, and removed from the lower mold. The release of pressure includes the state where some pressure is maintained to the extent that adhesion between the molding surface of the mold and the molded glass element is not lost.

The shape of the optical element formed by the manufacturing method of the present invention is not specifically limited other than that space be formed between the mold and the preform. An optical element molded surface that is convex and spherical or aspherical on the side(s) on which the space is formed, with the ratio of curvature of the preform shape being at least partially greater than that of the pressing mold, and thus forming a closed space between the preform and the mold, is particularly desirable.

That is, the molding surface of the mold on the side(s) on which the space is formed has a concave surface of radius of curvature r1 and the surface of the preform contacting this concave surface has a convex surface with a radius of curvature r0, where r1<r0. When the molded surface is an aspherical surface, the paraxial radius of curvature is made r1.

Nor is the size of the optical element specifically limited. However, for example, the optical element is desirably employed as a lens with an outer diameter of less than or equal to 10 mm, preferably with an outer diameter of less than or equal to 5 mm.

The use of the optical elements manufactured by the manufacturing method of the present invention is not specifically limited. For example, they are suitably employed as pick-up object lenses for optical disks, and may be employed in CD and DVD optical systems. Since these lenses are of the shape required to achieve a prescribed function, a closed space is sometimes formed with the mold, and the levels of shape precision and external appearance achieved are extremely high. In particular, in optical systems employing lasers of comparatively short wavelength (such as 450 nm or less), precision requirements are particularly strict. However, optical elements obtained by the manufacturing method of the present invention afford adequate performance.

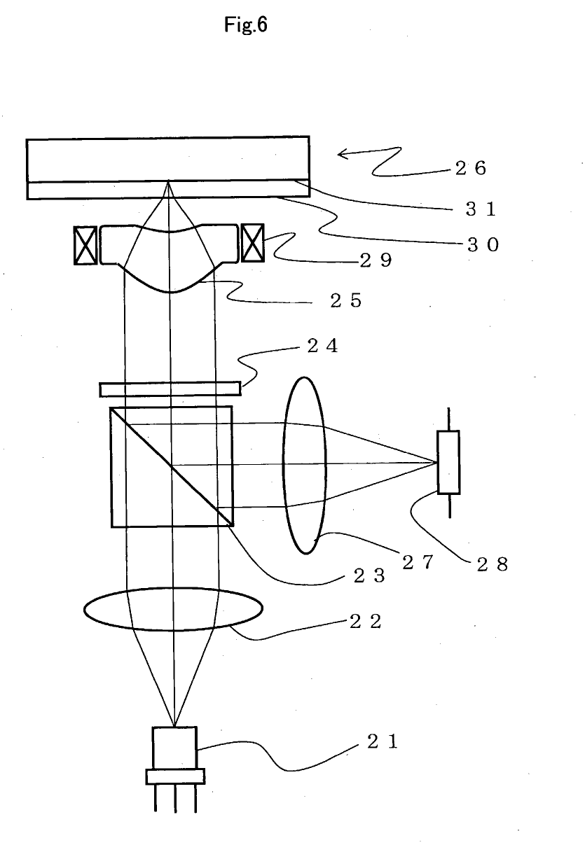

The present invention further relates to a pick-up optical unit for optical disks comprising an optical glass element manufactured by the method of manufacturing according to the above-mentioned present invention. A pick-up optical unit for optical disks may be an optical pick-up device illustrated in FIG. 6.

The optical pick-up device illustrated in FIG. 6 comprises a semiconductor laser 21, a collimator lens 22, a beam splitter 23, a ¼ wave plate 24, an iris (not shown in the Figure), an object lens 25, a detective condensing lens 27, a photo-detector 28 and an actuator 29. The device records and reproduces information on a disc 26. The pick-up optical unit of the present invention is the device of FIG. 6 from which a disc 26 is omitted. The object lens 25 in the device of FIG. 6 can be a glass optical element prepared by the method of the present invention.

Since the method of manufacturing a molded optical glass article of the present invention comprises a step of heating a preform through the mold on the side(s) on which space is formed with the preform in contact with the pressing mold, or a step of heating the preform by means of a gas flow or infrared radiation outside the pressing mold, the temperature in the vicinity of the preform surface in contact with the mold is raised relative to the center. At that time, since the center portion of the preform is at a temperature lower than the temperature range suited to molding, it has a viscosity greater than that near the surface. When pressing is conducted with the existence of a temperature distribution between the surface and center of the preform, that is, with a viscosity distribution having been produced, the center portion, with its high viscosity, reacts to the pressure, and is thought to push out the gas in the space formed between the mold and the preform.

Here, since the initial rate of movement of the mold pressing against the preform is made less than or equal to 10 mm/min, the initial pressure is gradually transmitted to the preform, the surface of the preform facing the space formed between the preform and the mold is gradually deformed, and the gas in the space tends to gradually expand radially and be discharged to the exterior. Subsequently, as heat is transmitted to the center portion of the preform and the pressing pressure is gradually increased, the pressing time can be shortened without damaging the molds.

### EXAMPLES

### Example 1

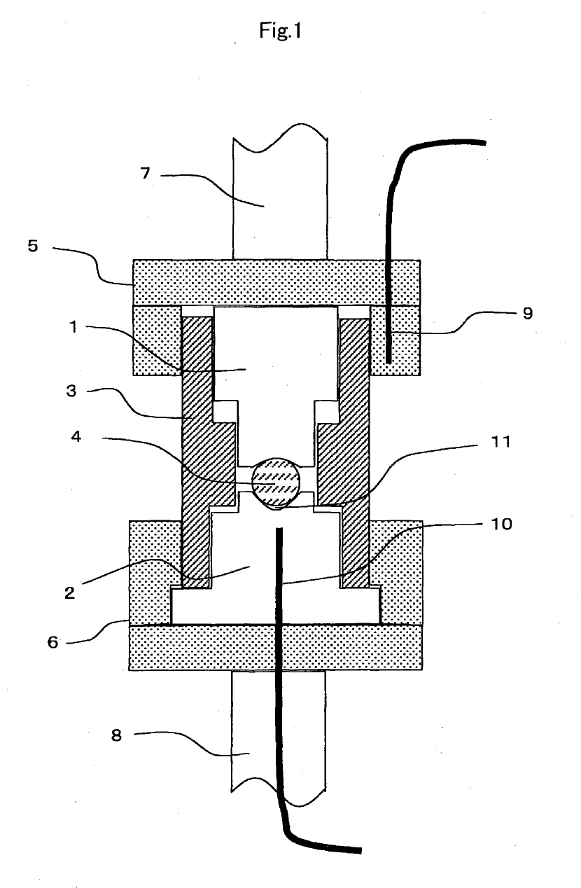

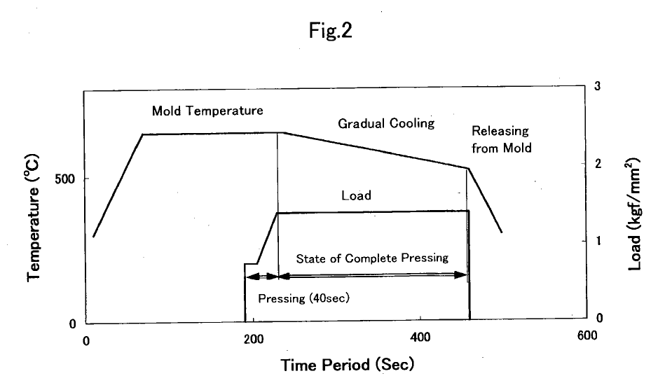

FIG. 1 is a vertical cross-sectional view of the perimeter portion of the mold of the press device for molded glass articles employed in Example 1 of the present invention. FIG. 2 is a press schedule of Example 1.

The configuration of the press device shown in FIG. 1 will be described first.

Preform 4 was a sphere manufactured by grinding to a diameter of 1.6 mm an optical glass material of nd=1.80610, νd=40.73, a yield temperature of 600° C., and a transition point temperature of 560° C. Preform 4 was placed at room temperature on the molding surface of a lower mold 2 with a molding surface radius of curvature of 0.67 mm. Next, upper mold 1 and sleeve 3 were set. A space 11 was formed between lower mold 2 and preform 3, with the maximum height in the center being 14 micrometers. In FIG. 1, the size of the space has been exaggerated for description. The upper mold, lower mold, and sleeve were made of SiC, and a DLC film was applied as a mold separation film on the molding surfaces.

Lower mold 3 was held in advance by lower mold heating member 6. Lower mold heating member 6 was attached with bolts to lower mold pressing member 8. Lower mold pressing member 8 was connected to a motor, not shown, and was moved vertically and pressed against the preform by the motor.

Upper mold heating member 5 was secured by bolts to upper mold securing element 7. When upper mold 1 and lower mold 2 were heated, as shown in FIG. 1, upper mold heating member 5 and lower mold heating member 6 were positioned so as to cover upper mold 1 and lower mold 2. At that time, upper mold heating member 5 was positioned with a gap so that pressure was not applied to upper mold 1. Lower mold temperature measuring thermocouple 10 was inserted into lower mold 2 and was used to regulate the temperature. Upper mold temperature measuring thermocouple 9 was inserted into upper mold heating member 5 and monitored the temperature balance between the upper and lower molds.

Based on the above configuration, a high-frequency induction coil (not shown) positioned around upper mold heating member 5 and lower mold heating member 6 heated upper mold heating member 5 and lower mold heating member 6. Here, upper mold heating member 5 and lower mold heating member 6 were made of a metal primarily comprised of tungsten and were capable of being heated by high frequency induction.

Pressing began at a temperature of 615° C., corresponding to a preform glass viscosity of 10^{9.2} poises. The upper and lower molds were heated, and when the temperature of the upper and lower molds reached the above-stated temperature, the temperature was maintained constant for 120 sec and heating of the preform was controlled.

Subsequently, the lower mold pressing member was lifted by a motor, not shown at a rate of about 100 mm/min to a position about 100 micrometers in front of where the upper surface of upper mold 1 came in contact with upper mold heating member 5. The lifting rate was then changed to 0.96 mm/min and further lifting was conducted. The pressure applied at 0.5 kgf/mm² permitted the lower mold to be maintained at a constant position. This pressure was then changed to 0.75 kgf/mm² and the preform was pressed.

A lifting rate of 0.96 mm/min was maintained from the beginning of the application of pressure on the preform until the lower mold pressing member had moved a distance of 20 micrometers, after which pressure was continuously increased at 0.05 kgf/mm²/sec. The moving rate at that time gradually increased, but as the preform deformed, the rate of movement became constant or decreased due to resistance to further deformation. When 40 seconds had elapsed, the top surface of upper mold 1 and the top surface of sleeve 3 coincided and pressing of the preform was ended. Subsequently, current was passed through the high-frequency coil while circulating nitrogen gas at a cooling rate of 60° C./min to conduct cooling. When the temperature dropped below the Tg of 560° C. to 550° C., the pressure was released and the molded article separated from the mold.

Conducting press molding with the above-described configuration and by the above-described method completely discharged the gas in the space formed between the preform and the lower mold, transferring the entire molding surface.

When the temperature of the molds at the start of pressing was high, the gas in the space tended not to disperse during pressing. When the mold temperature exceeded a temperature of 654° C. corresponding to a glass viscosity of 10^{7.4} poises, portions pitted by gas remaining in the center area were observed in some of the molded articles. Further, when the pressing temperature was lowered to less than 593° C., a temperature corresponding to a glass viscosity of 10^{10.5} poises, the pressed article could not be pressed to the desired thickness.

Accordingly, in this case, from the perspective of obtaining optical elements with good external appearance, a temperature corresponding to a glass viscosity of from 10^{7.4} to 10^{10.5} poises was suitable as the heating temperature of the molds at the start of pressing.

When the lower mold was displaced by the height h of the space and pressing was conducted, and the lifting rate of the lower mold was greater than or equal to 6 mm/min at a pressing temperature of 615° C., lenses in which the gas in the space formed between the preform and the lower mold did not discharge completely were obtained at a rate of about 20 percent. When 10 mm/min was exceeded, crizzles were produced in 50 percent or more of the molded glass articles. Accordingly, the suitable moving rate was less than or equal to 10 mm/min, preferably less than or equal to 6 mm/min. In this Example, the moving rate was made less than or equal to 1 mm/min, yielding stable continuous pressing.

Further, when the lifting rate of the lower mold was maintained from the start of pressing of the preform to a distance of just 13 micrometers, the gas in the space formed between the preform and the lower mold was not completely discharged. In this case, however, the gas in the space was discharged by maintaining the moving rate of the lower mold to the 14 micrometer height of space 11.

Further, when the distance of movement of the lower mold exceeded 14 micrometers and the rate of increase in the pressing load was made greater than or equal to 0.2 kgf/mm²/sec, crizzles were produced in 50 percent of the molded articles. When greater than or equal to 0.5 kgf/mm²/sec, the mold was destroyed.

Heating the preform while in a state of contact with the mold in this manner produced a difference in viscosity between the interior and surface portions of the preform, resulting in the portion near the center of the preform having a high viscosity. Since the molds were heated to a temperature corresponding to a glass material viscosity of from 10^{7.4} to 10^{10.5} poises, the portion of the preform surface in contact with the mold was heated to about the same temperature as the mold, gas in the space formed between the preform and the lower mold did not expand into the interior of the preform due to the press load, but in the high viscosity portion in the center of the preform, the space was pressed outward from the center by the action of the pressure applied, causing the gas in the space to be discharged to the perimeter without remaining, yielding a molded glass article of good external appearance. Further, since the moving rate of mold did not suddenly change the shape of the space, it could thinly extend toward the outer perimeter. Thus, the gas in the space was reliably discharged.

Since the gas in the space formed between the preform and the mold was reliably discharged in the present Example as set forth above, it was possible to manufacture a molded glass article of good external appearance. Further, since the mold damage, mold cracking, and crizzles in molded glass articles that are a concern when pressing glass of high viscosity were not produced, it was possible to continuously manufacture molded glass articles of high quality external appearance.

### Example 2

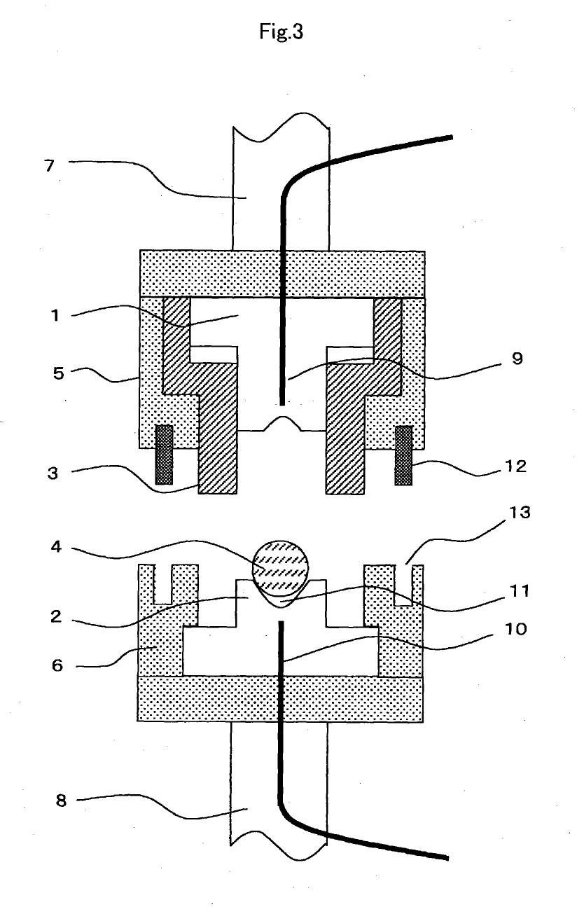

FIG. 3 is a vertical sectional view of Example 2 of the present invention. The pattern of the press schedule is identical to that of FIG. 2, but the pressing temperature and pressing load have been changed.

In Example 1, the preform was fed at room temperature, but in the present Example, a preheated preform was fed to pressing molds that had been heated to the pressing temperature, held for a certain period, and then press molded.

The configuration of FIG. 3 will be described first.

Upper mold 1 was positioned within a sleeve in a manner permitting sliding and held by upper mold heating member 5 as shown in FIG. 3. Lower mold 2 was held by lower mold heating member 6. Upper mold 1, lower mold 2, and sleeve 3 were made of an ultrahard alloy comprising WC, and the molding surfaces were coated with a mold separating film in the form of a film of noble metal.

Positioning pins 12 were provided in three spots in upper mold holding member 5, and positioning holes 13, for insertion of positioning pins 12, were provided in lower mold heating member 6. The positional relation was such that with positioning pins 12 inserted into positioning holes 13, and the lower surface of upper mold heating member 5 in contact with the upper surface of lower mold heating member 6, upper mold 1 and lower mold 2 pressed preform 4 within sleeve 3 to form a glass article in the form of a lens. Prior to pressing, the assembly was vertically separated as shown in FIG. 3.

Lower mold heating member 6 was bolted to lower mold pressing member 8. Lower mold pressing member 8 was connected to a motor, not shown, and was movable vertically by the motor to press the preform.

Upper mold heating member 5 was bolted to upper mold securing member 7.

Thermocouples 9 and 10 were inserted into upper mold 1 and lower mold 2, respectively. The heating temperature was controlled by lower mold heating thermocouple 9.

Preform 4 was a sphere that was manufactured by grinding to a diameter of 2.0 mm an optical class material with nd=1.73077, νd=40.50, a yield temperature of 535° C., and a transition point temperature of 500° C. Space, not shown, was formed between preform 3 and upper mold 1. The maximum height of this space was 10 micrometers. The maximum height of the space 11 formed between preform 3 and lower mold 2 was 20 micrometers.

Preform 4 was preheated to a temperature of 497° C. corresponding to a viscosity of 10^{13.5} poises by a heater, not shown.

First, upper and lower mold heating member 5 and 6 were heated by high-frequency induction coils (not shown) disposed about upper and lower mold heating members 5 and 6. Here, upper and lower mold heating members 5 and 6 were made of a metal comprised primarily of tungsten and were capable of high-frequency induction heating.

The temperature at the start of pressing of upper and lower molds 1 and 2 was 560° C., a temperature corresponding to a preform glass viscosity of 10^{7.9} poises; upper and lower molds 1 and 2 were heated to this temperature. Above-described preheated preform 4 was conveyed onto the molding surface of lower mold 2 by a preform conveying means, not shown.

Subsequently, the lower mold pressing member was lifted at a lifting rate of about 100 mm/min to a position where the upper surface of upper mold 1 was in contact with upper mold heating member 5 by a motor, not shown. After being maintained in that position for 60 sec, the lower mold pressing member was raised at a rate of 0.9 mm/min. The pressure of 0.5 kgf/mm² permitted the lower mold to be maintained at a constant position. The pressure was changed to 0.75 kgf/mm² and the preform was pressed. The lifting rate was maintained at 0.9 mm/min from the start of pressing of the preform to a distance of the lower mold pressing member of 100 micrometers. Subsequently, the pressure was continuously increased at a rate of 0.1 kgf/mm²/sec. After 20 sec, the upper end surface of lower mold heating element 6 came into contact with the lower end surface of the upper heating member and pressing of the preform was ended.

Subsequently, current was run through the high-frequency coil while circulating nitrogen gas to cool at a rate of 60° C./min. When a temperature of 480° C., lower than the Tg of 500° C., had been reached, the pressure was released and the molded glass article was removed from the mold.

By conducting press molding with the configuration and by the method set forth above, the gas in the space formed between the preform and the lower mold was completely discharged and the entire molding surface was transferred.

When the pressing temperature was raised in the same manner as in Example 1, the gas in the space tended not to discharge and optical elements with defective shapes were produced. When the mold temperature exceeded a temperature corresponding to a glass viscosity of 10^{7.4} poises, some of the molded articles were observed to have pitting due to gas remaining in the center portion. Further, when the pressing temperature was lowered to a temperature lower than the temperature of 518° C. corresponding to a glass viscosity of 10^{10.5} poises, pressing to desired thickness was precluded.

Accordingly, in this case, from the perspective of obtaining a good external appearance, the heating temperature of the molds was desirably made a temperature corresponding to a glass viscosity of from 10^{7.4} to 10^{10.5} poises. At a temperature corresponding to from 10^{7.5} to 10^{9.5} poises, the yield was good.

During pressing, when the lower mold was displaced by the height (h) of the space at a lifting rate of the lower mold exceeding 6 mm/min, the rate of production of lenses in the form of molded glass products in which the gas in the space formed between the preform and the lower mold did not completely discharge was 3 percent, and when 10 mm/min was exceeded, this rate was greater than or equal to 50 percent. In such cases, a lifting rate of less than or equal to 6 mm/min was desirable, but even at less than or equal to 10 mm/min, good products could be obtained. In the present Example, a rate of less than or equal to 1 mm/min was employed, permitting stable production.

When the above-described lifting rate of the upper mold was maintained from the start of pressing of the preform to a distance of only 29 micrometers, the gas in the space formed between the preform and the lower mold did not completely discharge. In this case, when the lifting rate of the upper mold was maintained to a distance of the lower mold of 30 micrometers, the sum of the heights of spaces 11 and 12, the gas in the space was discharged.

When the rate of increase in the press load was made greater than or equal to 0.2 kgf/mm²/sec, crizzles were produced in 2 percent of the molded glass articles, and when 0.5 kgf/mm²/sec was exceeded, crizzles were produced at a rate of greater than or equal to 50 percent. When further increased, the mold was damaged.

As set forth above, in the same manner as in Example 1, heating the preform while in contact with the mold produced a difference in temperature between the interior and surface portions of the preform, creating a high-viscosity portion near the center of the preform. Since the molds were heated to a temperature corresponding to a glass material viscosity of from 10^{7.4} to 10^{10.5} poises, the portion of the preform surface in contact with the mold assumed nearly the same temperature as the mold, gas in the space formed between the preform and the lower mold did not expand into the preform due to the pressing load, but in the high viscosity portion in the center of the preform, the space was pressed outward from the center by the action of the pressure applied, causing the gas in the space to be discharged to the perimeter without remaining, yielding a molded glass article with a good external appearance.

Further, since the mold moving rate applied above did not suddenly change the shape of the space, it could thinly extend toward the outer perimeter. Thus, the gas in the space was reliably discharged.

Further, since the preform was preheated to a temperature lower than the pressing temperature in the present Example, the time required to heat the preform was shorter than in Example 1, permitting a shortening of the tact time, improved production efficiency, and the obtaining of molded glass articles with good external appearance at a high yield.

Since an ultrahard alloy of good toughness is employed as the pressing mold material in the present Example, providing molds which are hardly damaged, tact shortening was possible even when the rate of increase in the pressing load was accelerated.

Based on the present Example as set forth above, the air in the space formed between the preform and the mold could be reliably discharged while shortening the tact time relative to Example 1, and it was possible to manufacture molded glass articles of good outer appearance.

### Example 3

The mold structure shown in the vertical cross-sectional view of FIG. 3 was also employed in the present Example. In the present Example, as shown in FIG. 5, preform 4 was heated while being floated on a hot gas flow blown upward. The gas flow was heated by passing through a pipe positioned within a preform floating member heated by an infrared lamp heater. A thermocouple for measuring the temperature was inserted into the preform floating member and employed to control the preform heating temperature.

The preform was a sphere that was manufactured by grinding to a diameter of 2.0 mm an optical class material with nd=1.69350, νd=53.20, a yield temperature of 560° C., and a transition point temperature of 520° C. A space, not shown, was formed between preform 3 and upper mold 1. The maximum height of this space was 8 micrometers. The maximum height of space 11 formed between preform 3 and lower mold 2 was 16 micrometers.

Preform 4 was heated by a heater, not shown, while being floated on a dish 14 equipped with blow holes and a conical receiving member on an inert gas fed by a floating gas line 16 on a floating arm 15 equipped with floating gas line 16 feeding an inert gas for floating, as shown in FIG. 5. Since the heating temperature of preform 4 could not be directly measured, a temperature sensor (thermocouple), not shown, mounted on floating arm 15 was used to measure and control the temperature. Inert gas was heated while passing through the floating gas line. Here, the preform was heated to a temperature of 603° C. corresponding to 10^{7.5} poises. Once heated to a prescribed temperature, floating arm 15 was moved by a drive mechanism, not shown, so that preform 4 was positioned directly above lower mold 2 in FIG. 3. Floating arm 15 was fashioned so as to be separated from the center. When the floating gas was stopped with floating arm 15 separated in the direction of the arrow shown in FIG. 5, preform 4 was fed by dropping onto lower mold 2. Upper and lower molds 1 and 2 were heated to 603° C. by high-frequency induction coils. Once preform 4 had been fed by dropping, floating arm 15 was retracted. The retracted floating arm was again loaded with a preform and the preform was heated. The lower mold pressing member was lifted upward by a motor, not shown, at a lifting rate of about 100 mm/min until just before the upper surface of the preform 4 came into contact with the molding surface of upper mold 1, at which point the lifting rate was changed to 2.4 mm/min and lifting was continued. The pressure was 0.75 kgf/mm². A lifting rate of 2.4 mm/min was maintained from the start of pressing of the preform until the lower mold pressing member reached the distance of 50 micrometers. Subsequently, the pressure was continuously increased by 1 kgf/mm²/sec, and pressing of the preform was ended at the point where the lower end surface of the upper mold heating member came into contact with the upper end surface of lower mold heating member 6 without exceeding 3 kgf. Subsequently, nitrogen gas was circulated to cool at a cooling rate of 60° C./min while passing current through a high-frequency coil. When 500° C. was reached, the pressure was released and the molds were separated. Once the lower mold had been moved downward, the pressed lens was removed. The upper and lower molds were again heated, a heated preform was fed, and pressing was repeated.

By conducting press molding with the above-described configuration and by the above-described method, the gas in the space formed between the preform and the lower mold was completely discharged and the complete molding surface was transferred.

When the mold temperature was raised or the preform heating temperature was raised, the gas in the space tended not to discharge and optical elements with defective shapes were produced. When the mold temperature exceeded 606° C. corresponding to 10^{7.4} poises, pitted portions were observed in some of the molded articles due to gas remaining in the center portion.

Error of the preform temperature occurs due to it being measured by a temperature sensor (a thermocouple in the present Example) mounted on the floating arm. It is thus desirable to correlate in advance the temperature measured by the thermocouple mounted on the floating arm with the temperature measured by a noncontact temperature sensor such as a radiation thermometer or a thermoviewer.

When pressing was conducted with the above steps and the lower mold lifting rate exceeded 6 mm/min from the start of preform pressing, the rate at which lenses in which the gas in the space formed between the preform and the lower mold was not completely discharged, as in Example 2, were produced was about 3 percent, and when 10 mm/min was exceeded, greater than or equal to 50 percent.

Heating the preform outside the molds to a prescribed temperature of T1 as set forth above afforded the advantages of permitting floating heating, preventing surface defects in the glass material, and shortening the molding tact.

As set forth above, the gas in the space formed between the preform and the mold was reliably discharged and a molded glass article with a good external appearance was manufactured in the present Example even when the tact was shortened to a greater degree than in Example 2.

According to the present manufacturing methods, the molds were heated to a prescribed temperature falling within a range corresponding to a viscosity of the optical glass material of from 10^{7.4} to 10^{10.5} poises, the surface portion was hotter than the interior portion, a glass material within a temperature range at which the surface portion thereof exhibited a viscosity of from 10^{7.4} to 10^{10.5} poises was fed, and pressing was conducted at a mold moving rate of less than 10 mm/min corresponding to the height of the closed space. Thus, space deformation due to gas in the space formed between the preform and the mold was thinly extended toward the perimeter and [gas] was reliably discharged, permitting the manufacture of molded glass articles having good external appearance. Further, since the mold damage, mold cracking, and crizzles in molded glass articles that are a concern when pressing glass of high viscosity were inhibited, it was possible to continuously manufacture molded glass articles of high quality external appearance.

The present disclosure relates to the subject matter contained in Japanese Patent Application No. 2002-185474 filed on Jun. 26, 2002, which is expressly incorporated herein by reference in its entirety.

1. A method of manufacturing optical glass elements by press molding a glass material with a pressing mold comprising an upper mold and a lower mold, at least one of the upper mold and the lower mold being vertically movable,
at least one of the upper mold and the lower mold having a shape such that when the glass material is in contact with the upper mold and the lower mold, a molding surface of at least one of the upper mold or the lower mold forms a closed space with a surface of the glass material,
which method comprising:
supplying a glass material, at a temperature of less than a temperature at which the glass material exhibits a viscosity of 10¹¹ poises, between the upper mold and the lower mold
heating the supplied glass material by thermal conduction by means of contact with the upper mold or lower mold on the side on which the space is formed, and,
moving at least one of the upper mold and the lower mold at an average moving rate of less than or equal to 10 mm/min at least for a distance h micrometers after the glass material becomes in contact with the upper mold and the lower mold, when a temperature of the pressing mold is at a predetermined temperature T2 within a range in which the glass material exhibits a viscosity of from 10^{7.4} to 10^{10.5} poises,
wherein a maximum height of the space in the direction of the moving of the movable mold is denoted as h micrometers.

2. The method of claim 1 wherein at least one of the upper mold and the lower mold which forms the closed space has a concave surface with a paraxial radius of curvature r1 in the molding surface and the surface of the glass material which forms the closed space with the molding surface has a convex surface with a radius of curvature r0, wherein r1<r0.

3. The method of claim 2 wherein a pressure applied to the glass material by moving at least one of the upper mold and the lower mold is increased on or after the time when the moving distance of said mold reaches the distance h micrometers after the glass material becomes in contact with the upper mold and the lower mold.

4. The method of claim 3 wherein the average increasing rate of the pressure is less than or equal to 0.5 kgf/mm² per second.

5. The method of claim 4 wherein the average moving rate of at least one of the upper mold or the lower mold is increased on or after the time when the moving distance of said mold reaches the distance h micrometers after the glass material becomes in contact with the upper mold and the lower mold.

6. A method of manufacturing optical glass elements by press molding a glass material with a pressing mold comprising an upper mold and a lower mold, at least one of the upper mold and the lower mold being vertically movable,
at least one of the upper mold and the lower mold having a shape such that when the glass material is in contact with the upper mold and the lower mold, a molding surface of at least one of the upper mold or the lower mold forms a closed space with a surface of the glass material,
which method comprising:
supplying a glass material between the upper mold and the lower, and moving at least one of the upper mold and the lower mold at an average moving rate of less than or equal to 10 mm/min at least for a distance h micrometers after the glass material becomes in contact with the upper mold and the lower mold, when a temperature of outer surface of the supplied glass material is higher than the interior of the glass material and the outer surface is at a predetermined temperature T1 within a range in which the glass material exhibits a viscosity of from 10^{7.4} to 10^{10.5} poises,
and the temperature of the pressing mold is at a predetermined temperature T2 within a range in which the glass material exhibits a viscosity of from 10^{7.4} to 10^{10.5} poises,
wherein a maximum height of the space in the direction of the moving of the movable mold is denoted as h micrometers.

7. The method of claim 6 further comprising heating the glass material so that the outer surface of the glass material reaches a temperature T1 in which the glass material exhibits a viscosity of from 10^{7.4} to 10^{10.5} poises prior to supplying the glass material between the upper mold and the lower mold.

8. The method of claim 7 wherein at least one of the upper mold and the lower mold which forms the closed space has a concave surface with a paraxial radius of curvature r1 in the molding surface and the surface of the glass material which forms the closed space with the molding surface has a convex surface with a radius of curvature r0, wherein r1<r0.

9. The method of claim 8 wherein a pressure applied to the glass material by moving at least one of the upper mold and the lower mold is increased on or after the time when the moving distance of said mold reaches the distance h micrometers after the glass material becomes in contact with the upper mold and the lower mold.

10. The method of claim 9 wherein the average increasing rate of the pressure is less than or equal to 0.5 kgf/mm² per second.

11. The method of claim 10 wherein the average moving rate of at least one of the upper mold or the lower mold is increased on or after the time when the moving distance of said mold reaches the distance h micrometers after the glass material becomes in contact with the upper mold and the lower mold.

12. An optical pick up unit comprising a semiconductor laser source, a collimator lens, a beam splitter, a ¼ wave plate, an iris, an object lens, a detective condensing lens, a photo-detector, and an actuator, wherein the object lens is manufactured by the method of claim 1.

13. An optical pick up unit comprising a semiconductor laser source, a collimator lens, a beam splitter, a ¼ wave plate, an iris, an object lens, a detective condensing lens, a photo-detector, and an actuator,
wherein the object lens is manufactured by the method of claim 2.
